(19) United States
(12) Patent Application Publication
(10) Pub. No.: US 2008/0006069 A1
(43) Pub. Date: Jan. 10, 2008

(54) Electromagnetic lock

(76) Inventor: Li-Shih Liao, Yangmei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,102

(22) Filed: Sep. 19, 2007

Related U.S. Application Data
(63) Continuation-in-part of application No. 11/272,708, filed on Nov. 15, 2005.

(51) Int. Cl. E05B 47/08

(52) U.S. Cl. 70/413

(57) ABSTRACT

An electromagnetic lock with a receiving space defined by a housing and a cover, comprising a lock catch, an solenoid valve, an adjusting unit, and a decoration plate all of which are received within the receiving space. The lock catch is pivotally coupled to a housing by a positioning shaft in match of a torque maintaining element. The solenoid valve includes a movable shaft and an end stop adapted to the lock. The position of the end stop is changeable when a voltage is applied to the solenoid valve, thereby determining whether or not the lock catch is engaged into the bottom of the housing. The adjusting unit includes an slide carriage to receive the solenoid valve. A restoring spring is interposed between the slide carriage and a fixing piece. The adjusting unit further includes an adjusting element with an operating head sitting on a free side of the cover for controlling the position switching of the slide carriage, thereby controlling the position of the solenoid valve carried by the slide carriage relative to the lock catch. Accordingly, the electromagnetic lock may be brought into an unlocked or locked state.

### BACKGROUND OF THE INVENTION

1. Field of the Invention

The present invention relates to locks and more particularly, to an electromagnetic lock that can be conveniently and selectively adjusted between two reversed modes, allowing the magnetic lock to be locked or unlocked when electrically connected.

2. Description of the Related Art

Conventional magnetic locks include two types, the type that is locked when electrically connected, and the type that is unlocked when electrically connected. It greatly complicates the manufacturer's inventory control and the related management cost to fabricate these two types of magnetic locks. Taiwan patent publication no. 384904, filed by the present inventor on Apr. 14, 1998, discloses a magnetic lock, which has the electromagnetic valve adjustable between two positions to have the magnetic lock be locked or unlocked when electrically connected.

U.S. Pat. No. 6,299,225 issued on Oct. 9, 2001, discloses a magnetic lock entitled ┌Electrical Lock Device┘. According to this design, as shown in FIGS. 8A and 8B, comprises a housing 60, a lever 61, a solenoid device 62, a top cover 63, and a shell 64. The solenoid device 62 is mounted on a mount 621, having a plunger 622 slidably received therein and a block 623 secured to the plunger 622. The mount 621 has bottom screw holes 624. The housing 60 has an elongated slot 65, and two screw holes 66 spaced from the elongated slot 65 at different distances. A adjustment screw 67 and a tie screw 68 are respectively mounted in the elongated slot 65 and one screw hole 66 of the housing 60 and threaded into corresponding screw holes 624 to alternatively secure the mount 621 in the space 601 inside the housing 60 at a position where the solenoid device 62 is disengaged from the lever 61 when the solenoid device 62 is energized and at the other position where the solenoid device 62 is engage with the lever 61 when the solenoid device 62 is energized. When wishing to change the position of the solenoid device 62 (the mount 621), the user must remove the top cover 63 and unfasten the tie screw 68. This solenoid device position adjustment procedure is complicated. In addition, the housing 60 is embedded in the door after the electromagnetic lock is mounted on the door 80 (see FIG. 8C). Accordingly, it is not possible for the user to adjust the operation mode by himself. As a result, the current is applied to the solenoid device 62 all day long even if no control of entrance is required for a specific period (like the working time when the office is accessible for all people), thereby causing a long-term power waste. Thus, it does not meet the power-saving requirements.

U.S. Pat. No. 6,874,830 discloses another structure of magnetic lock, entitled ┌Electric Strike Assembly┘. According to this design, as shown in FIGS. 9A, 9B and 9C the electric strike assembly comprises a housing 70, a keeper 71 pivotally arranged in the housing 70, and a holder 73 slidably arranged in the housing 70, a blocking element 74 slidably arranged in the holder, 73 and configured to selectively prevent a rotation of the keeper 71 and allow the rotation of the keeper 71, an actuator 72 configured to selectively move the blocking element 74, a two-position mode selector 76 operable from outside the housing 70 and configured to selectively move the holder 73 from a first position to a second position and vice versa, and a bottom cover 77 covering the housing 70. The selector 76 has a slotted head 61, an eccentric disc portion 63, and a pin 62. When the holder 73 is in the first position, the blocking member 74 allows the rotation of the keeper 71 when the actuator 72 is energized and prevents the rotation of the keeper 71 when the actuator 72 is not energized, and when the holder 73 is in the second position, the blocking member 74 prevents the rotation of the keeper 71 when the actuator 72 is energized and allows the rotation of the keeper 71 when the actuator 72 is not energized. This design of magnetic lock is complicated. Further, it is inconvenient to operate the selector 76 to further adjust the position of the holder 73.

### SUMMARY OF THE INVENTION

It is a primary object of the invention to eliminate the above-mentioned drawbacks and to provide an electromagnetic lock that permits a free adjustment of the locked or unlocked state.

It is another object of the invention to provide an electromagnetic lock that meets the power-saving requirement.

In order to achieve the above-mentioned objects, an electromagnetic lock in accordance with the invention includes a receiving space defined by a housing and a cover. A lock catch, a solenoid valve, an adjusting unit, and a decoration plate are received within the receiving space.

The lock catch is pivotally coupled to a housing by a positioning shaft in match of a torque maintaining element.

The solenoid valve includes a movable shaft and an end stop adapted to the lock. The position of the end stop is changeable when a voltage is applied to the solenoid valve, thereby determining whether or not the lock catch is engaged into the bottom of the housing.

The adjusting unit includes an slide carriage to receive the solenoid valve. A restoring spring is interposed between the slide carriage and a fixing piece. The adjusting unit further includes an adjusting element with an operating head sitting on a free side of the cover for controlling the position switching of the slide carriage, thereby controlling the position of the solenoid valve carried by the slide carriage relative to the lock catch. Accordingly, the electromagnetic lock may be brought into an unlocked or locked state.

The decoration plate is positioned at the bottom of the cover for sheltering the internal elements.

### BRIEF DESCRIPTION OF THE FIGURES

The accomplishment of this and other objects of the invention will become apparent from the following descriptions and its accompanying figures of which:

FIG. 1 is a perspective view of the invention;

FIG. 2 is an exploded perspective view of the invention;

FIG. 3 is a first schematic drawing of the invention, illustrating the unlocked state by application of power;

FIG. 3A is a cross-sectional view taken along the line 3A-3A of FIG. 3;

FIG. 3B is a cross-sectional view taken along the line 3B-3B of FIG. 3;

FIG. 4 is a second schematic drawing of the invention, illustrating the unlocked state by application of power;

FIG. 4A is a cross-sectional view taken along the line 4A-4A of FIG. 4;

FIG. 5 is a first schematic drawing of the invention, illustrating the locked state by application of power;

FIG. 5A is a cross-sectional view taken along the line 5A-5A of FIG. 5;

FIG. 5B is a cross-sectional view taken along the line 5B-5B of FIG. 5;

FIG. 6 is a second schematic drawing of the invention, illustrating the locked state by application of power;

FIG. 6A is a cross-sectional view taken along the line 6A-6A of FIG. 6;

FIG. 7 is a schematic drawing of the invention mounted on a door, illustrating the adjustment thereof;

FIG. 8A is an exploded view of an electrical lock device according to U.S. Pat. No. 6,299,225;

FIG. 8B is an elevational assembly view of the electrical lock device according to U.S. Pat. No. 6,299,255;

FIG. 8C is a schematic view of a conventional electromagnetic lock mounted on the door;

FIG. 9A is an exploded view of an electric strike assembly according to U.S. Pat. No. 6,874,830;

FIG. 9B is an elevational assembly view of a part of the electric strike assembly according to U.S. Pat. No. 6,874,830; and

FIG. 9C is an elevational view of the mode selector for the electric strike assembly according to U.S. Pat. No. 6,874,830.

### DETAILED DESCRIPTION OF THE PREFERRED EMBODIMENT

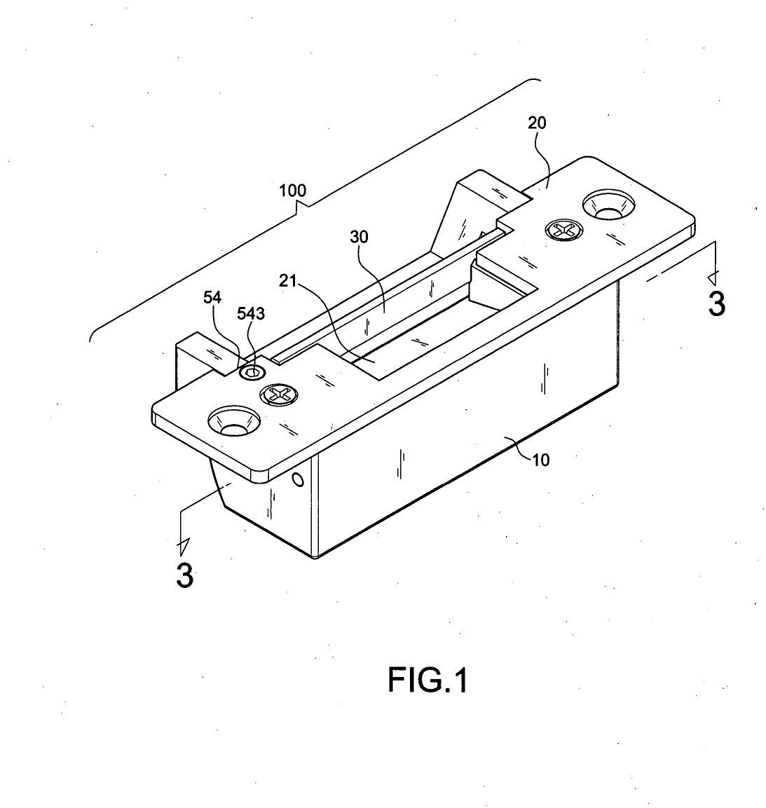

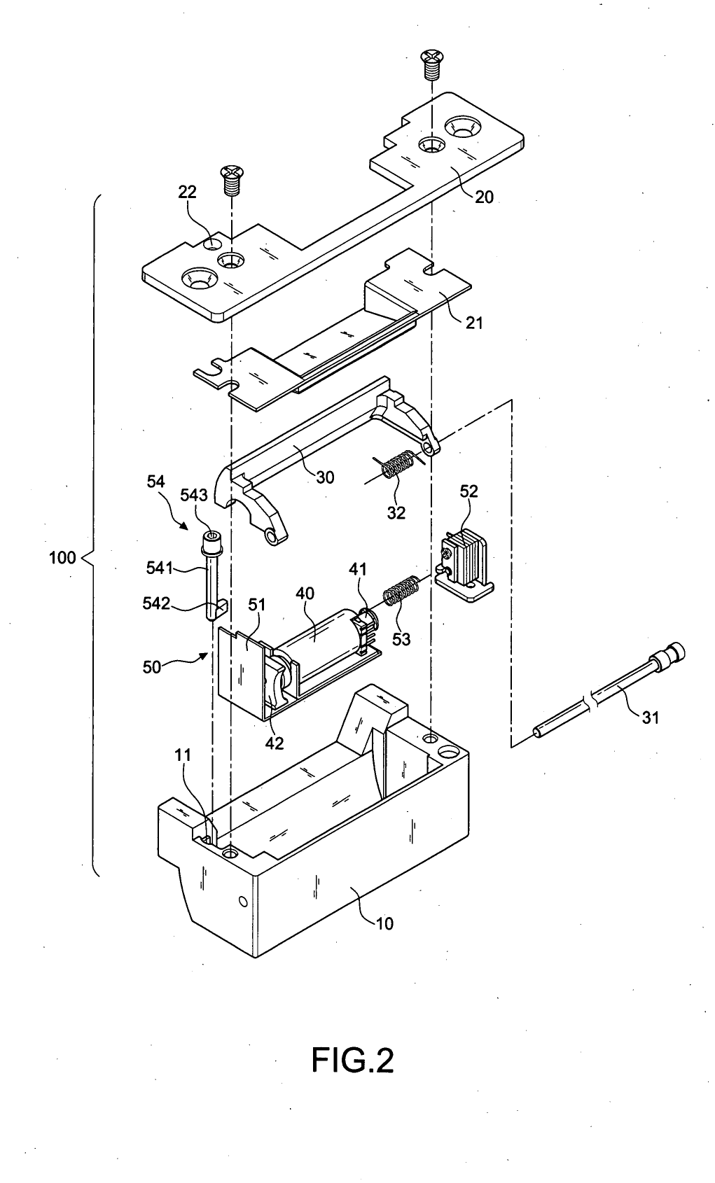

First of all, referring to FIGS. 1 and 2, an electromagnetic lock 100 in accordance with the invention includes a receiving space defined by a housing 10 and a cover 20. A lock catch 30, an solenoid valve 40, an adjusting unit 50, and a decoration plate 21 are received within the receiving space.

The lock catch 30 is pivotally coupled to the housing 10 by a positioning shaft 31 in match of a torque maintaining element 32 like a torsion spring.

The solenoid valve 40 includes a movable shaft 41. An end stop 42 adapted to the lock catch 30 is disposed at a position opposing to the movable shaft 41. The position of the end stop 42 is changeable when a voltage is applied to the solenoid valve 40, thereby determining whether or not the lock catch 30 is engaged into the bottom of the housing 10.

The adjusting unit 50 includes an L-shaped slide carriage 51 to receive the solenoid valve 40. A restoring spring 53 is interposed between the L-shaped slide carriage 51 and a fixing piece 52. The adjusting unit 50 further includes an adjusting element 54 with an operating head 543 sitting on a free side of the cover 20 for controlling the position switching of the L-shaped slide carriage 51. In other words, the operating head 543 of the adjusting element 54 is extended into a round hole 22 of the cover 20. The adjusting element 54 in accordance with the invention includes a stem 541 at the bottom of the operating head 543 and a push lug 542 perpendicular to the bottom of the stem 541, thereby forming an L-shape body like a golf club. The adjusting element 54 is disposed within a recess 11 at the side of the housing 10. The push lug 542 rests against the external side of the vertical side of the L-shaped slide carriage 51. In use, the stem 541 is rotated by the operating head 543 so as to push the push lug 542 against the L-shaped slide carriage 51 for displacement. In this way, the position of the solenoid valve 40 carried by the L-shaped slide carriage 51 relative to the lock catch 30 is controllable. Accordingly, the electromagnetic lock may be brought into an unlocked or locked state.

The decoration plate 21 is positioned at the bottom of the cover 20 for sheltering the internal elements.

Besides, the operating head 543 in accordance with the invention includes a hexagonal socket nut. Thus, an Allen wrench is required for controlling the tightening action. However, it should not be restricted thereto.

Moreover, the fixing piece 52 can be an opposite side of the housing 10. Alternatively, the fixing piece 52 can be replaced by a fixing seat of the housing 10.

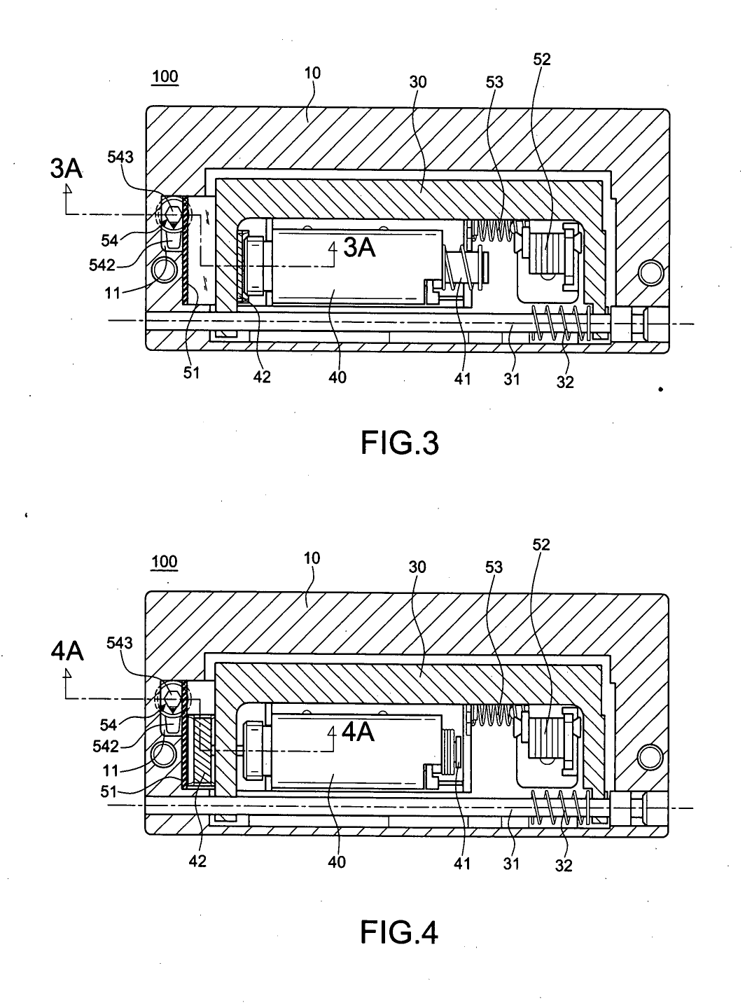

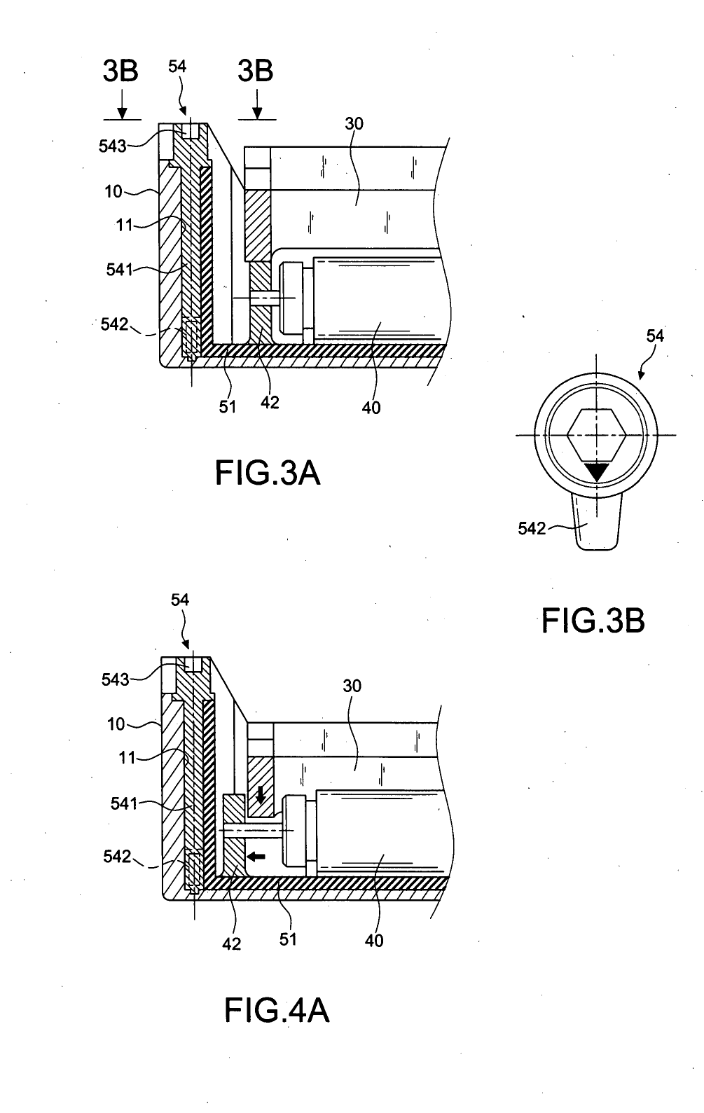

Based on the above-mentioned configuration (see FIGS. 3 and 4), the end stop 42 is situated just at the place to block the lock catch 30 to be engaged into the bottom of the housing 10 (see FIG. 3A) when the L-shaped slide carriage 51 is maintained by the adjusting element 54 of the adjusting unit 50 in a first position (see FIG. 3B) and the voltage is still not applied to the solenoid valve 40. As the current is applied to the solenoid valve 40, the end stop 42 will no more block the lock catch 30 to be engaged into the bottom of the housing 10 (see FIG. 4A). In this way, a door will be “unlocked by application of power”.

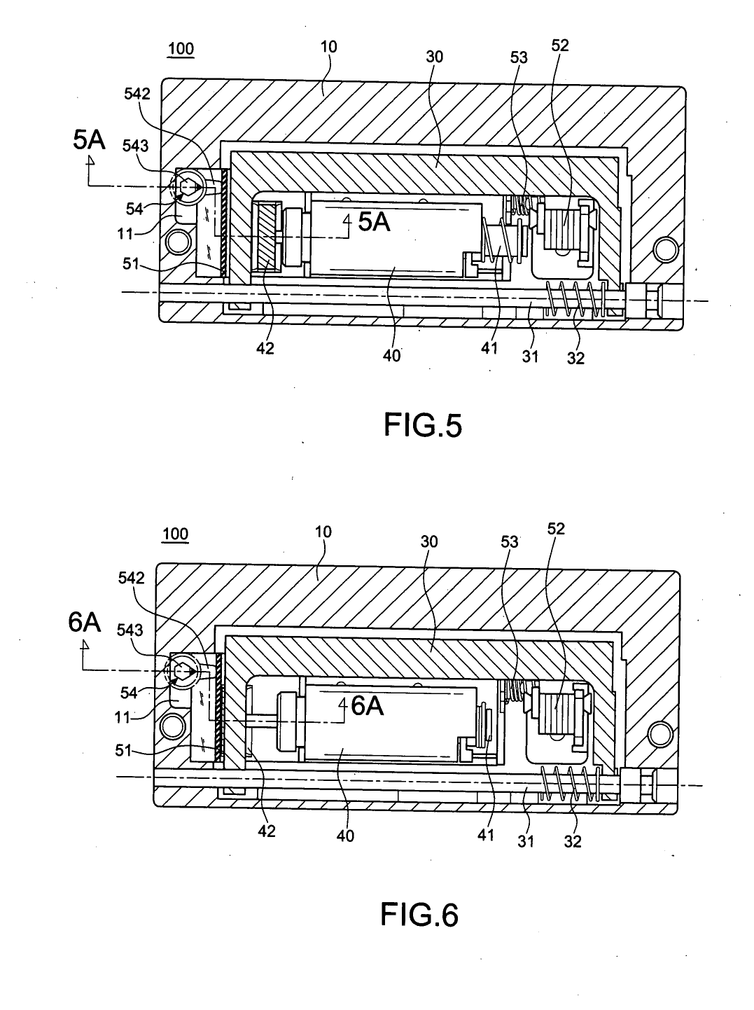

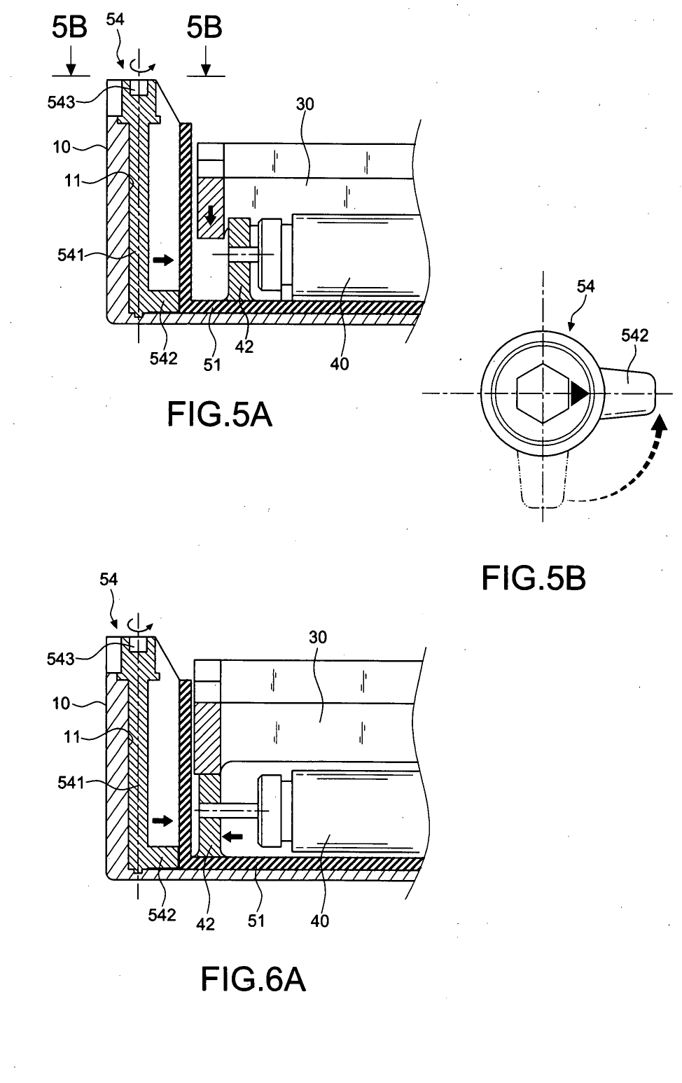

Please now refer to FIGS. 5 and 6. The stem 541 of the adjusting element 54 of the adjusting unit 50 is rotated at 90 degree (see FIGS. 5A and 5B) to push to the push lug 542 against the L-shaped slide carriage 51 for an inward shift in a second position. The end stop 42 won't block the lock catch 30 to be engaged into the bottom of the housing 10 prior to the application of power (see FIG. 5A). As the current is applied, the fixing piece 52 may just block the lock catch 30 to be engaged into the bottom of the housing 10 (see FIG. 6A). In this way, a door is “locked by application of power”.

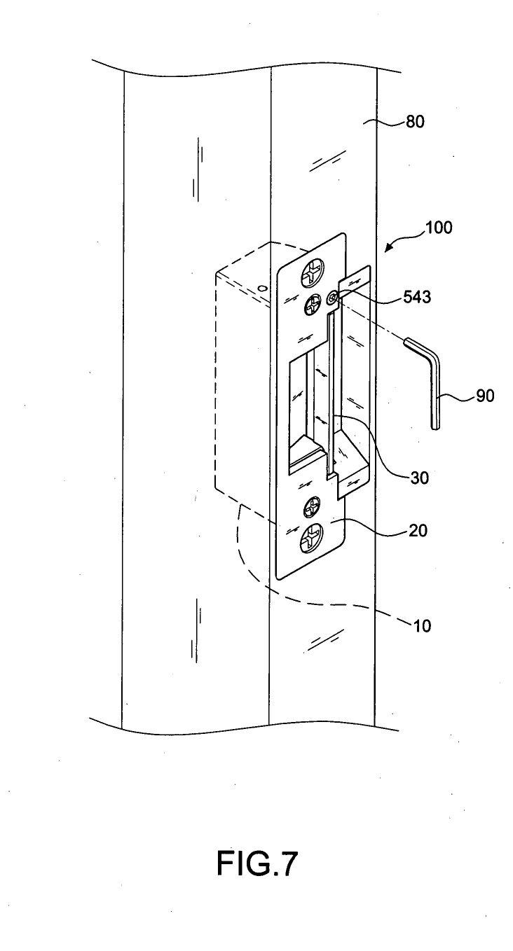

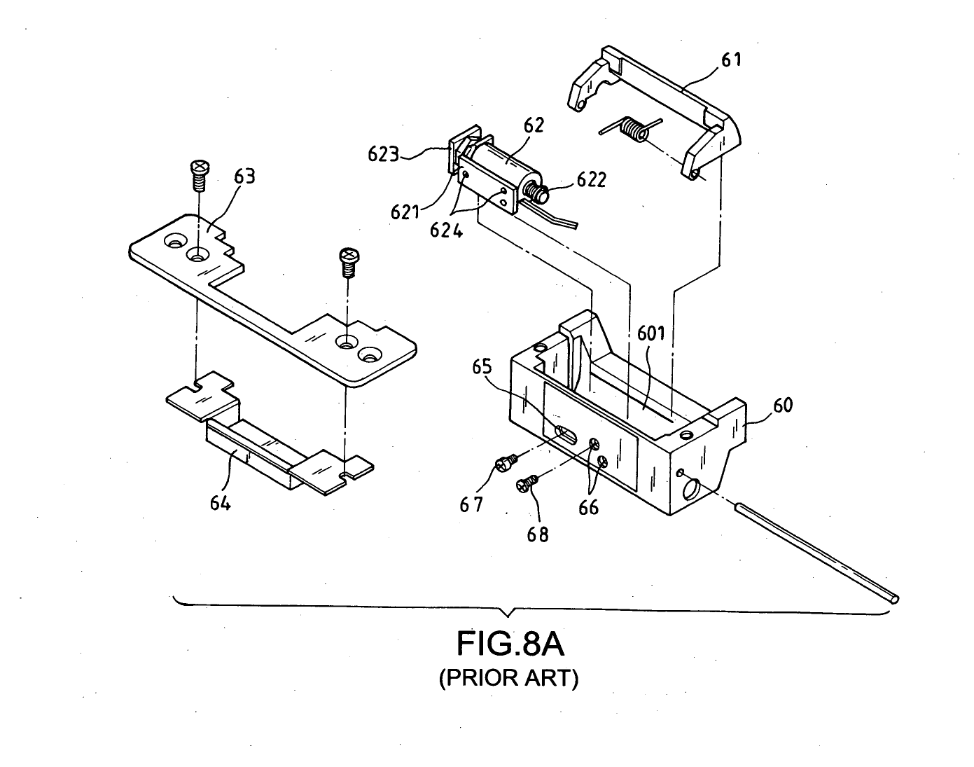

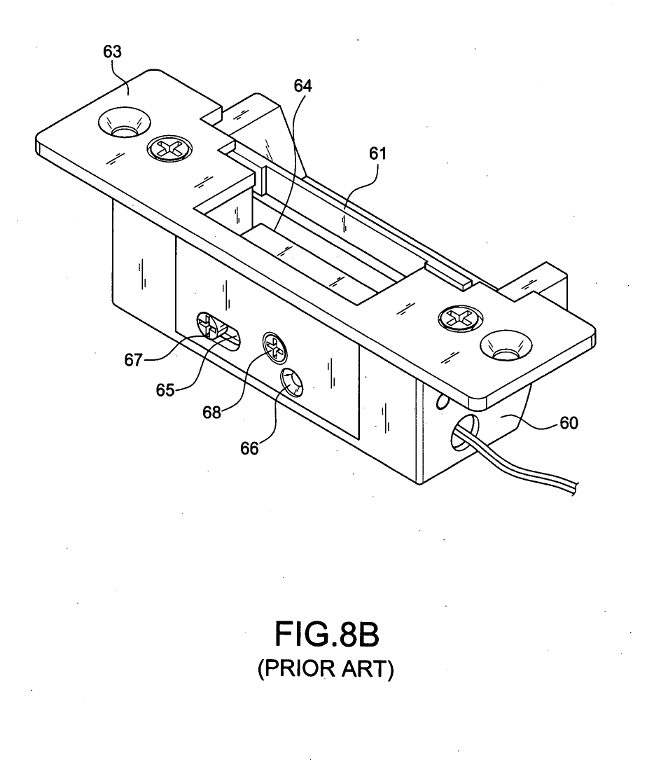

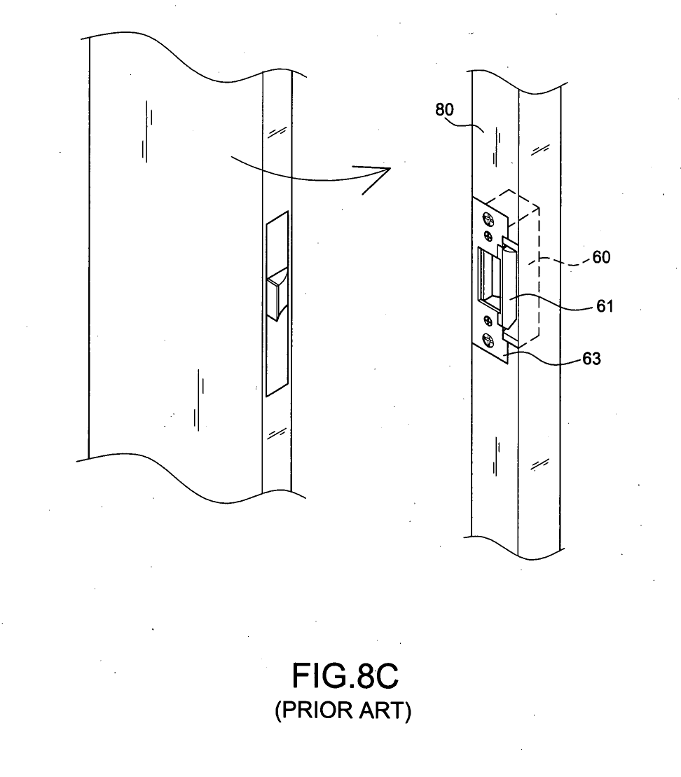

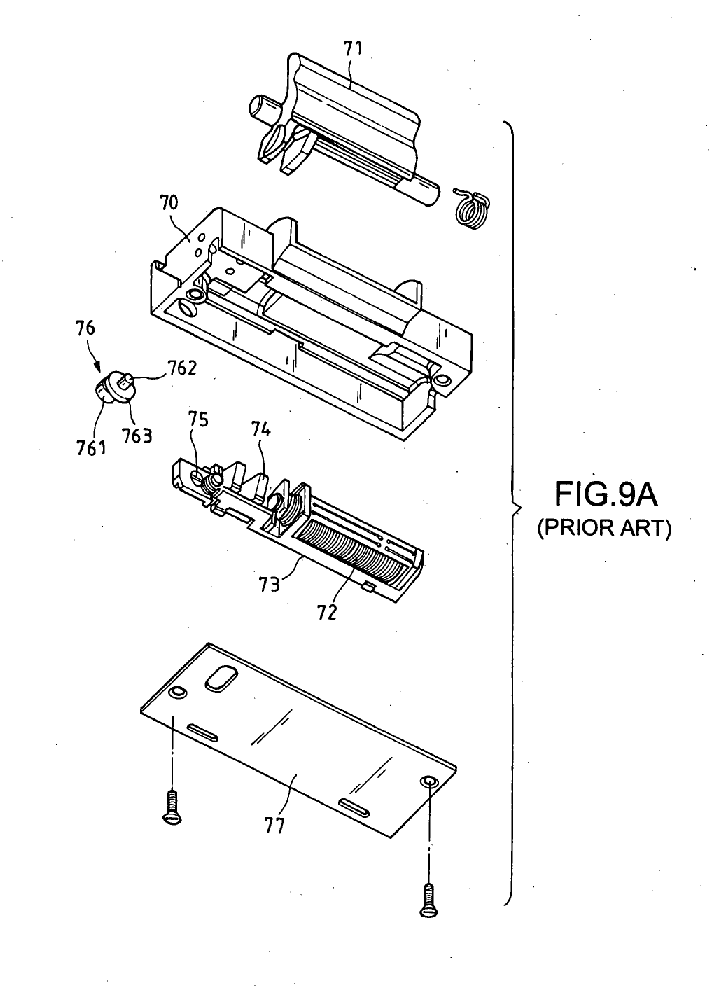

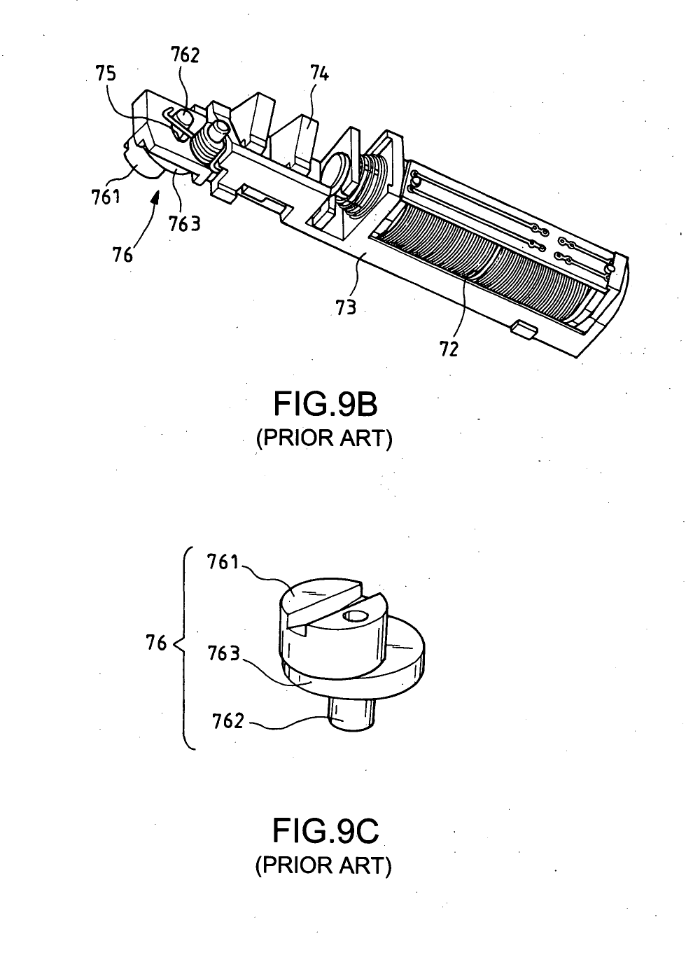

Accordingly, a door can be unlocked or locked in application of power by means of the position change of the L-shaped slide carriage 51 through the adjusting element 54. In other words, the unlocked or locked state of the electromagnetic lock may be changed. Since the operating head 543 of the adjusting element 54 is positioned at the free side of the cover 20, it is possible for the operator to undergo a desirable change by use of a simple tool 90 when the electromagnetic lock is mounted onto a door 80 (see FIG. 7). As a result, the operator may freely adjust the locked or unlocked position.

Based on the above-mentioned features, the electromagnetic lock has a few application possibilities. For example, the electromagnetic lock may be applied at a site where no control of entrance is required at a specific time (such as an office accessible by any person at the working period). In this case, the door can be set “unlocked by application of power” only when the control of entrance has to be done. That is, the power is only applied when people want to enter or leave the office. Meanwhile, the door can be set “locked by application of power” at a specific period when no control of entrance is required. That is, the office will be freely accessible for any person without application of power to the solenoid valve 40. As a result, the time of the application of power to the solenoid valve can be reduced for saving energy by changing the locked and unlocked state of the electromagnetic lock according to different needs in use.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An electromagnetic lock with a receiving space defined by a housing and a cover, comprising a lock catch, an solenoid valve, an adjusting unit, and a decoration plate all of which are received within the receiving space;
wherein the lock catch is pivotally coupled to a housing by a positioning shaft in match of a torque maintaining element;
wherein the solenoid valve includes a movable shaft and an end stop adapted to the lock, and the position of the end stop is changeable when a voltage is applied to the solenoid valve, thereby determining whether or not the lock catch is engaged into the bottom of the housing; and
wherein the decoration plate is positioned at the bottom of the cover for sheltering the internal elements;
characterized in that the adjusting unit includes an L-shaped slide carriage to receive the solenoid valve, and a restoring spring is interposed between the L-shaped slide carriage and a fixing piece, and the adjusting unit further includes an adjusting element with an operating head sitting on a free side of the cover for controlling the position switching of the L-shaped slide carriage, and the adjusting element is disposed within a recess at the side of the housing, and the adjusting element includes a stem at the bottom of the operating head and a push lug at the side of the stem, and the push lug rests against the external wall of the vertical side of the L-shaped slide carriage, thereby controlling the position of the solenoid valve carried by the L-shaped slide carriage relative to the lock catch; accordingly, the electromagnetic lock may be brought into an unlocked or locked state.

2. The electromagnetic lock as recited in claim 1 wherein the operating head of the adjusting element includes a hexagonal socket nut.

3. The electromagnetic lock as recited in claim 1 wherein the fixing piece is an opposite side or a fixing seat of the housing.

4. The electromagnetic lock as recited in claim 1 wherein the torque maintaining element is a torsion spring.
